(19) United States
(12) Patent Application Publication
(10) Pub. No.: US 2008/0168131 A1
(43) Pub. Date: Jul. 10, 2008

(54) Platform for defining single-page web signup facilities

(75) Inventors: Reid Maker, Seattle, WA (US); Arun Rajappa, Redmond, WA (US); Volodymyr Otryshko, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/650,704

(22) Filed: Jan. 8, 2007

(51) Int. Cl. G06F 15/16

(52) U.S. Cl. 709/203

(57) ABSTRACT

Embodiments of the invention provide a platform for defining a single-page signup facility which includes a plurality of modules. In some embodiments, the platform is flexible and extensible in that different modules may be developed by different parties and incorporated in, removed from and modified within various signup facilities. Some embodiments allow multiple variations of each signup facility to be defined, each variation providing a different user experience. Modules may be swapped in and out of various experiences without requiring any changes to the platform itself. The effectiveness of different experiences in converting users to signed-up customers may be measured.

### FIELD OF INVENTION

This invention relates to techniques for designing web pages which present information to a user, and more particularly to techniques for designing web page signup facilities.

### BACKGROUND OF INVENTION

Many web sites provide facilities which a user may employ to order, register for, sign up for, or otherwise establish a relationship with a product and/or service (these facilities are referred to generically herein as “signup facilities,” and the process by which a relationship is created between the user and the product/service a “signup process”). Conventionally, a signup facility includes one or more web pages which accept user input of various information to complete the signup process (referred to herein as “signup information”), such as the user's first and last name, billing and/or mailing address, credit card number, and/or other information.

Conventionally, if a substantial amount of information is to be collected from a user via a signup process, a signup facility presents multiple web pages to the user, each web page allowing the user to provide a portion of the signup information required. The user typically provides a first portion of signup information to a first web page and indicates (e.g., by clicking on a “continue” button on the page) that the process should continue to the next page. When this occurs, browser software executing on the user's device (e.g., a personal computer, cell phone, personal digital assistant or other device) transmits the signup information to a server along with a request for the next web page in the signup facility. The server computer receives the signup information, retrieves the next web page, and transmits it to the browser. The user may experience a delay while the browser generates information and transmits it to the server, and the server processes the received information and transmits the next page back to the browser.

### SUMMARY OF INVENTION

Some embodiments of the invention provide a platform which may be employed to define a signup facility which provides the user with a visual indication of the steps to be completed during the signup process on a single page. In some embodiments, the platform allows an administrator to define a single-page signup facility which presents a plurality of modules on the page, each module being designed to collect a portion of the signup information needed.

In some embodiments, the platform includes features which allow modules to be developed separately and operate independently, but also to be combined with other modules in a signup facility which, when presented to the user, perform and present information to the user in a consistent manner. In this respect, a platform implemented in accordance with embodiments of the invention may include code which is downloaded to the client for managing the execution of modules on the client. This client-side platform code may accommodate any type, number and arrangement of modules, such that any type of module may be included in any signup facility presented via the client without changes to the platform. Further, modules may be swapped in and out of signup facilities without requiring changes to the platform. For example, in some embodiments, the client-side platform code performs event handling functions, such that modules need not be provided with these capabilities and so that functionality provided by the platform may be further modularized. As a result, the platform may scale to accommodate any desired number of modules and/or signup facilities, for any desired number of users, products and/or experiences. For example, different parties may develop different modules. These modules may, for example, be arranged in various combinations to create any number of signup facilities and/or experiences.

In one embodiment, the platform allows an administrator to define various user experiences that may be presented to a user who requests a particular signup facility. Each experience may include a different combination, number, or arrangement of modules on the signup facility page. In this manner, an administrator may define multiple variations of the signup facility. This may be done for several reasons. For example, different experiences may be defined for different versions of a product, such that a first experience is defined for a first version and a second for a second version. Different experiences may also present a different offer or marketing message for a particular product. Different experiences may also be presented to different users so as to test the effectiveness of each in converting users to signed-up customers. In this respect, in some embodiments, the platform provides the capability to report on the effectiveness of different experiences and/or modules at converting users to customers.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIGS. 1A-1C each depict an exemplary graphical user interface displaying a single-page signup facility in accordance with some embodiments of the invention;

FIG. 2 is a block diagram depicting exemplary components for providing a signup facility in accordance with some embodiments of the invention;

FIG. 3 is a flowchart depicting an exemplary technique for performing error handling in relation to providing a single-page signup facility, in accordance with some embodiments of the invention;

FIG. 4 is a flowchart depicting an exemplary method for defining a module for inclusion in a single-page signup facility or variation thereof, in accordance with some embodiments of the invention;

FIG. 5 is a block diagram depicting an exemplary computer system on which aspects of embodiments of the invention may be implemented; and

FIG. 6 is a block diagram depicting an exemplary computer memory on which programmed instructions comprising embodiments of the invention may be stored.

### DETAILED DESCRIPTION

Some embodiments of the invention provide a platform for defining signup facilities that may be presented to a user via a single web page, such that the user is given a clear visual indication of the overall scope of the signup process and the amount and type of signup information to be provided. Each signup facility may include a plurality of modules, wherein each module is designed to collect a portion of the signup information to be collected overall. In some embodiments, the platform includes features which allow modules to be developed separately and operate independently, but also to be combined with other modules in a signup facility which, when presented to the user, perform and present information to the user in a consistent manner.

In some embodiments, the platform may include code which is downloaded to the client for managing the execution of various modules thereon. This client-side platform code may be generic in that it may accommodate any type, number and arrangement of modules, such that any type of module may be included in any signup facility presented via the client without changes to the platform. As a result, any number of signup facilities, incorporating any number, type and combination of modules, may be developed, for any number of products, services and/or users. Modules may be swapped in and out of various signup facilities without requiring changes to the platform. In some embodiments, client-side platform code performs event handling functions, such that modules need not be provided with these capabilities and so that functionality provided by the platform overall may be further modularized.

In addition, some embodiments allow for the definition of multiple variations of each signup facility, such that different experiences may be presented to users who request the signup facility. Each experience may, for example, include a different combination, number, or arrangement of modules on the page. As such, different content may be presented to different users, and/or the effectiveness of each presentation in converting users to signed-up customers may be tracked. Some embodiments of the invention also provide the capability to report on the effectiveness of experiences and/or particular modules in converting users to customers.

These and other features described in further detail below enable the platform to scale to accommodate any desired number of modules and/or signup facilities, to support any desired number of users, products and/or experiences. In the sections that follow, a brief overview is provided of one example of a single-page signup facility, followed by a description of a platform for defining a single-page signup facility, and various functionality provided thereby, implemented in accordance with embodiments of the invention.

### I. Single-Page Signup Facility

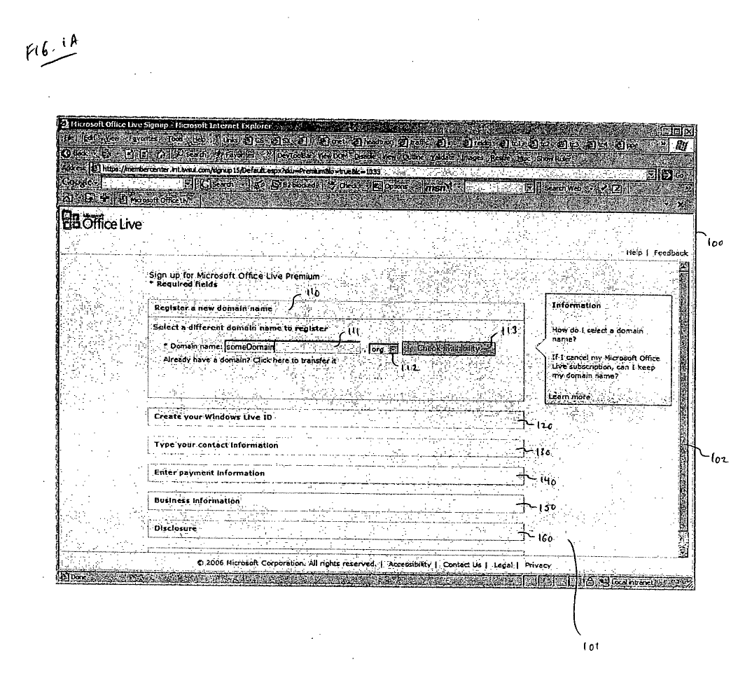

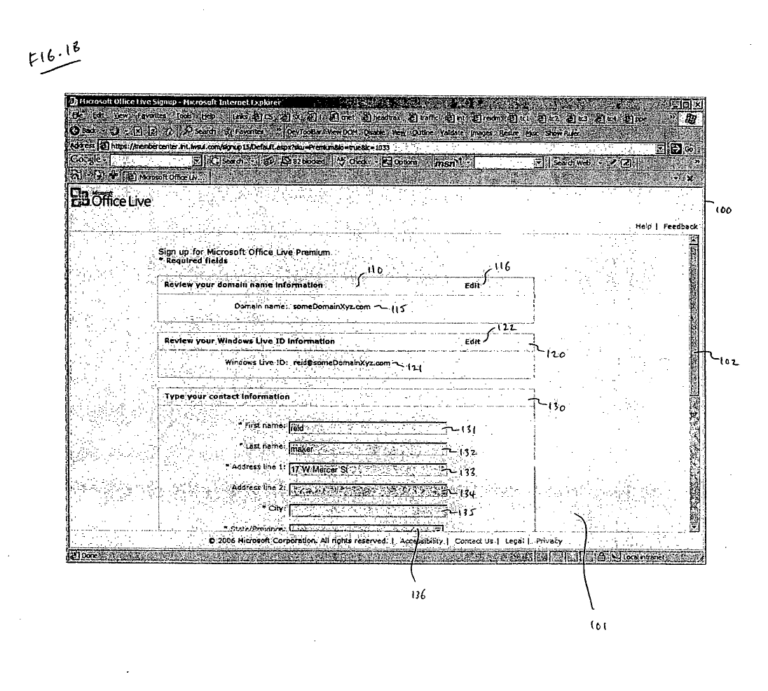

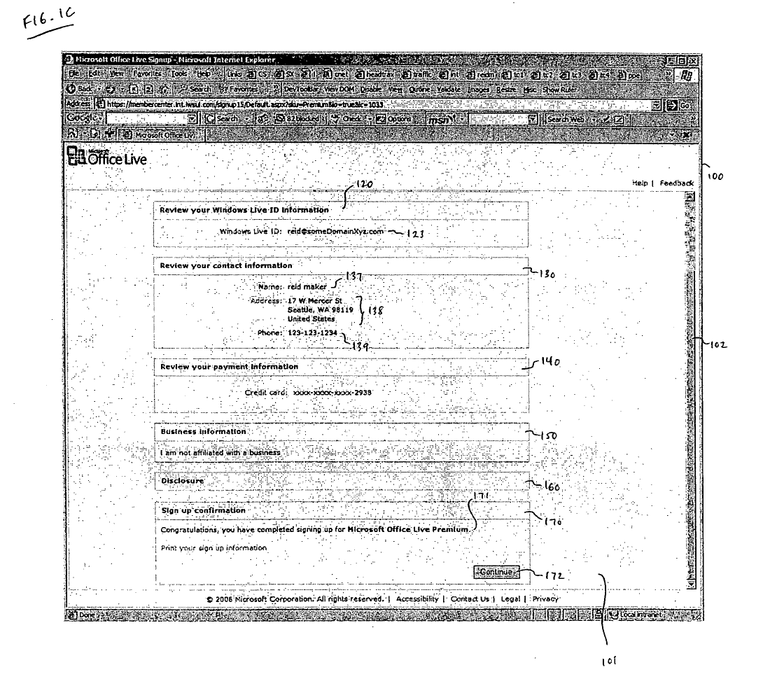

FIGS. 1A-1C each depict one example of a signup facility 101 which includes a plurality of modules for collecting signup information from a user. FIGS. 1A-1C each depict graphical user interface (GUI) 100 presented via browser software, which in the example shown is Microsoft Internet Explorer, offered by Microsoft Corporation of Redmond, Wash. However, any suitable browser software may be employed. In addition, GUI 100 may be presented via browser software executing on any suitable device, including a personal computer, personal digital assistant, cellular telephone, or other device, as the invention is not limited in this respect.

In the example shown in FIGS. 1A-1C, in order to show multiple modules on a single page, each module is capable of changing state. That is, when a module is not actively receiving signup information from a user, it is presented in a collapsed state to conserve viewable area on the page. When a user indicates a desire to provide signup information to a particular module, that module may change from a collapsed state to an expanded state, wherein one or more input mechanisms (e.g., text boxes, dropdown menus, buttons, and/or other mechanisms) are presented to capture user input. After the user has provided input to that module, or otherwise indicates a willingness to proceed to another module, the module may change to a summary state wherein a portion of the input provided by the user is displayed. The next module may then automatically expand to display one or more input mechanisms. In this manner, multiple modules may be presented in a single viewable area while also giving the user a visual indication of his or her progress in the signup process.

It should be appreciated that although the signup facility depicted in FIGS. 1A-1C includes modules capable of changing state, a platform implemented in accordance with embodiments of the invention need not enable the definition of signup facilities with modules having this capability. A signup facility may include any one or more modules, each having (or not having) any capabilities, as the invention is not limited to a particular implementation.

In the example shown, signup facility 101 allows a user to provide signup information to order the Microsoft Office Live Premium product offered by Microsoft Corporation. In this example, providing signup information includes registering a new domain name via module 110, creating a Windows Live ID via module 120, providing contact information via module 130, entering payment information via module 140, providing business information via module 150, and acknowledging disclosure information via module 160. Of course, a signup facility implemented in accordance with embodiments of the invention may accept and/or present any suitable information, as the invention is not limited in this respect. In the example shown, modules 110-160 are presented in approximately a single viewable area, such that the user is given a clear sense of the types of information to be provided in the signup process overall without having to scroll down the web page (e.g., using scroll bar 102).

In FIG. 1A, module 110 is shown in an expanded state, such that it presents input mechanisms 111, 112 and 113. More particularly, module 110 presents text box 111, drop-down box 112 and button 113. Any suitable number and type of input mechanisms may be presented by a module, as the invention is not limited in this respect. Further, in some embodiments, the input mechanisms presented by a module are designed to collect a logically related portion of the signup information. For example, in this case input mechanisms 111, 112 and 113 allow the user to provide information relating to registering a domain name. Specifically, text box 111 allows the user to specify a domain name to be registered, drop-down box 112 allows the user to select from a list of top-level domains, and button 113 allows the user to check the availability of the domain specified via input mechanisms 111-112. Of course, other types or combinations of input mechanisms may be provided to collect this information from a user.

FIG. 1A depicts signup facility 101 as the user provides input to module 110, such that the user has not yet reached any of modules 120-160. In contrast to module 110, each of modules 120-160 is shown in a collapsed state. In some embodiments, a module is shown in a collapsed state when a user has not yet reached (e.g., provided input to) the module, so that the module occupies a minimal amount of the viewable area on the page. However, the invention is not limited to such an implementation, as modules which have not received information need not be shown in a collapsed state.

FIG. 1B depicts exemplary signup facility 101 as the user provides input to module 130 (e.g., after having provided input to module 110 as shown in FIG. 1A, and to module 120 via interaction which is not shown). In the example shown, modules 110 and 120 are shown in a summary state, such that each presents a summary of the input provided by the user to the module. Specifically, module 110 presents text 115 which indicates the domain name specified by the user via module 110 when the module was in the expanded state (as shown in FIG. 1A). Module 110 also presents link 116, which the user may click to edit the domain name indicated by text 115. In some embodiments, by clicking on link 116, the user may cause module 110 to change to the expanded state to present text box 111, drop-down box 112 and button 113 to allow the user to specify a new domain name, although the invention is not limited to such an implementation. Clicking on link 116 may also cause module 130 to change back to the summary state, so as to not occupy viewable area on the page. However, the invention is not limited to presenting any module in any particular state when a user indicates a desire to modify input previously provided. For example, module 110 may remain in a summary state but present a single text box that enables the user to change the domain name, and/or module 130 may remain in an expanded state whether or not module 110 changes to an expanded state. Embodiments of the invention may be implemented in any suitable fashion.

In the example shown in FIG. 1B, module 130 allows the user to provide contact information. In the example shown, module 130 is in an expanded state, and presents text boxes 131-135, via which the user may specify his or her first name, last name, “address line 1,” “address line 2” and city, respectively. The user may employ drop-down box 136 to specify his or her state.

It should be appreciated that by presenting modules to which the user has already provided input in a summary state, the module(s) to which the user is currently providing input in an expanded state, and the module(s) to which the user has yet to provide input in a collapsed state, the exemplary signup facility shown provides a clear indication of where the user is in the signup process, what information has been provided, and what information the user has yet to provide in the signup process overall.

FIG. 1C depicts exemplary signup facility 101 after the user has completed the signup process. In the example shown, each of modules 120-160 is shown in a summary state, and presents a summary of input provided by the user. In the example shown, none of modules 120-160 provide a mechanism to allow the user to edit this input (e.g., via a link similar to link 116 shown in FIG. 1B), as the user has completed the signup process and the information has been recorded. Of course, the invention is not limited to such an implementation, as a mechanism may be provided to modify various input.

Module 170 presents a congratulatory message to the user via text 171 indicating that the signup process has been completed. Button 172 allows the user to proceed to another page (e.g., to exit the signup facility). For example, by clicking button 172, the user may proceed to a page which allows him or her to use the product or service for which he or she has registered.

It should be appreciated that signup facility 101 and the modules displayed thereby are merely exemplary, and that signup facilities and/or modules defined by a platform implemented in accordance with embodiments of the invention may differ in any of numerous respects from the signup facility and modules shown. For example, a single-page signup facility need not employ modules capable of changing state, as any one or more modules, having any suitable capabilities, may be employed. If modules are capable of changing state, a module in an expanded state need not display the types of input mechanisms described above with reference to FIGS. 1A-1C, as type or combination of input mechanisms may be employed to collect information from a user. Similarly, a signup facility need not initially show all modules in a collapsed state, as any suitable number (including zero) of modules may be shown in any state at any one time. In addition, a module in a summary state may display any type or combination of information, including information not provided by a user. The invention is not limited to any particular implementation.

### II. System for Defining/Delivering Signup Facilities

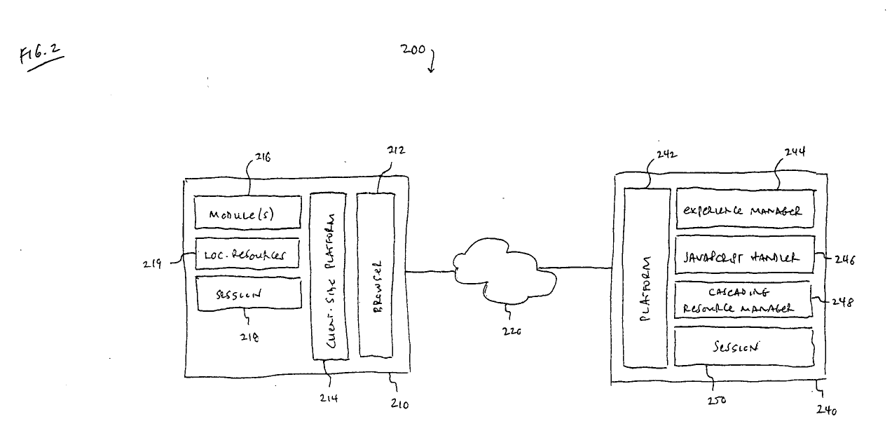

Some embodiments of the invention provide components constituting a platform for defining various modules and/or for delivering those modules to a user via single-page signup facilities. FIG. 2 depicts an exemplary system 200 which includes components loaded on client computer 210 and server 240. Implemented on server 240 are components which allow any number and type of modules, signup facilities and/or experiences to be defined for presentation to the user. These components may allow modules to be defined by various parties and to be presented to the user via a signup facility (or variation thereof, as defined by an experience).

Server 240 includes server-side platform component 242, experience manager 244, Javascript handler 246, cascading resource manager 248, and server session data 250. Server-side platform component 242 receives web page requests from browser 212 (e.g., a request for a single-page signup facility), and responds to those requests by providing components to client 210 (i.e., client-side platform component 214, module(s) 216, localized resources 219 and session data 218) which enable a signup facility including any suitable number, type and combination of modules to be presented to a user. When executed on client 210, these components may perform processing tasks which enable functionality to be modularized, as described below.

Server-side platform component 242 manages the execution of experience manager 244, Javascript handler 246 and cascading resource manager 248. Specifically, when a request issued by client 210 is received at server 240 by server-side platform component 242, an experience to be presented to the user via a single page signup facility is determined. As described above, in some embodiments, server-side platform component 242 is capable of presenting multiple variations of a single-page signup facility to browser 212, wherein each variation includes a different combination and/or number of modules for presentation to the user. For example, different modules may be included, and/or modules may be arranged in different ways, in each variation of the signup facility so as to create a particular experience. This may be done for any of numerous reasons. In one example, a first experience may be defined for a first (e.g., basic) version of a product/service, and another user experience may be defined for a second (e.g., premium) version of the product/service. In another example, different user experiences may each define a different offer or marketing message with respect to a particular product/service. In yet another example, different experiences may each define the same offer or marketing message, but may be presented to different users to test the effectiveness of different user experiences in converting users to signed-up customers.

To determine the experience that is to be presented to the user via the sign-up facility, in some embodiments, server-side platform component 242 determines the product or service to which the request relates. This information may be provided, for example, within the request issued by client 210. For example, the uniform resource locator (URL) defined by the request (e.g., defined by a link clicked by the user) may define the product or service to which the request relates.

Server-side platform component 242 communicates with experience manager 244, which determines the experiences available for the product or service and which experience is to be presented to the user. This determination may be made in any of numerous ways. For example, if there are multiple experiences available for the product or service, experience manager 244 may employ an algorithm to determine which experience is presented to the user. As an example, if user experiences A and B are available for presentation, an algorithm may define that experience A is presented to eighty percent of users, and experience B is presented to twenty percent of users. Experience manager 244 may employ the algorithm to define whether experience A or B is presented to the user, and communicate the chosen experience to server-side platform component 242.

Server-side platform component 242 may also communicate with cascading resource manager 248 to determine whether and/or which localized resources should be provided to the client for use in presenting the signup facility. In this respect, in accordance with some embodiments of the invention, sever-side platform 242 is capable of presenting a signup facility to a user that is customized according to certain characteristics of the user's request, such as the geographic location from which it originates. For example, a signup facility may be presented which includes modules and/or input mechanisms labeled with text in a language and/or character set which is appropriate for a particular geographic location.

In some embodiments, server-side platform component 242 determines whether localized resources are to be provided, using information provided in the request issued by the client 210. For example, the uniform resource locator (URL) defined by the request (e.g., defined by a link clicked by the user) may define whether localized resources are to be provided. For example, the user may have clicked a link to order a German language version of a specific product/service, or the URL defined by the request may have a top-level domain (e.g., .de) which indicates that the request is issued from Germany. Server-side platform component 242 may communicate with cascading resource manager 248, which determines whether localized resources are required for the signup facility and, if so, retrieves those resources.

Server-side platform component 242 may also communicate with Javascript handler 246 to determine the information needed to present the signup facility to the user. In some embodiments, script files maintained by Javascript handler 246 are provided to client 210 to present the experience determined by experience manager 244 in the manner defined by cascading resource manager 248. Server-side platform component 242 may communicate with Javascript handler 246 so that it may retrieve these files. This may be done in any of numerous ways. For example, in some embodiments, server-side platform component 242 communicates one or more identifiers for the determined experience and/or localized resources to Javascript handler 246, which retrieves the files which are then provided to client 210.

Server-side platform component 242 may then transmit a response, in the form of the files provided by Javascript handler 246, to client 210. The files constituting the response, when implemented on client 210, define client-side platform 214, module(s) 216, session data 218 and localized resources 219.

It should be appreciated that the processing techniques described above are merely exemplary, and that a single page signup facility having the capabilities and features described herein may be presented to a user using any suitable processing technique. Further, it should be appreciated that the steps described above need not be performed in the manner or order described, that any of these processing steps may be omitted or replaced, and that one or more additional processing steps may be performed. Numerous variations are possible. In addition, a platform for defining single-page signup facilities having the features and capabilities described herein may be implemented using any suitable type and/or combination of components, and is not limited to the components described with reference to FIG. 2. Any of the functionality described above with reference to various components of system 200 may be provided by any suitable component, including components not shown. For example, instructions and data defining a signup facility need not comprise separate client-side platform, module and localize resource files as data and instructions may be organized in any number of functional components (including one). The invention is not limited to any particular implementation.

### III. Client-Side Processing

A. Overview

In some embodiment, client-side platform 214 is designed to be generic in that any number and type of module(s) 216 may be presented via a signup facility. This design may allow for modularization of different aspects of the system for presenting signup facilities and experiences. For example, certain capabilities, such as navigation between modules, changing module states, etc., may be performed generically by client-side platform 214 regardless of the characteristics of any particular module 216, such that each module 216 need not be provided with capabilities for controlling these functions. As a result, different modules may be developed by different parties, and presented within a single signup facility that creates the impression that the modules are integrated. In addition, particular modules may be added, modified or replaced without changes to the platform.

As described above, client-side platform 214 may orchestrate the execution of module(s) 216 to present a single-page signup facility. For example, using the example described above with reference to FIGS. 1A-1C, client-side platform 214 may, when a user indicates a desire to move from module 120 to module 130 (FIG. 1B), orchestrate the execution of module 120 so that it changes from an expanded state to a summary state, and of module 130 so that it changes from a collapsed state to an expanded state.

In some embodiments, one or more of module(s) 216 may be implemented as Javascript objects including programmed instructions which, when executed by browser 212, may cause portions of a web page display to change appearance, such as by changing state as described above. In addition, in some embodiments, one or more of module(s) 216 may communicate asynchronously with server-side platform component 242, such that information may be exchanged between client 210 and server 240 without requiring a web page refresh on client 210, as described below.

B. Event And Error Handling

As noted above, client-side platform 214 may provide event handling capabilities, such that module(s) 216 need not be provided with these capabilities. As a result, module(s) 216 may be swapped in and out of various signup facilities without changes to client-side platform 214.

In one example, client-side platform 214 may perform a check with one or more of module(s) 216 when a user indicates a desire to conclude the signup process, to determine whether this is desirable. In some embodiments, when the user indicates a desire to conclude the signup process (e.g., by clicking a “purchase” button provided by the signup facility), client-side platform 214 may poll one or more of module(s) 216 included in the signup page to determine whether allowing the user to conclude the process is desirable.

Allowing a user to conclude the signup process may be undesirable for several reasons. For example, a particular module may be performing processing (e.g., making a call to a web service) which should be completed before the signup process is concluded. Using the example described above with reference to FIGS. 1A-1C, a user may provide input to all of modules 110-160, then decide to change the domain name via module 110 (e.g., by clicking link 116, FIG. 1B), then immediately attempt to conclude the signup process. Given that the email account specified in module 120 is driven by the domain name specified in module 110, concluding the signup process immediately after the domain name is changed may not be desirable, since module 120 may be attempting a network call to determine whether the email account corresponding to the new domain name is available.

In some embodiments, client-side platform 214 polls module(s) 216 to determine whether concluding the signup process is desirable. If a module is processing a network call, or otherwise indicates that the process should not be finished, client-side platform 214 may not allow it to do so. For example, client-side platform may present a message to the user indicating that he or she should wait a short period, then try again to conclude the process. If no module indicates that the process should not be concluded, client-side platform 214 may allow the process to finish.

Client-side platform 214 may also provide the capability of handling errors encountered by particular modules. In this respect, a module may encounter an error message that it is not capable of handling and which should be handled by another module. For example, a signup facility may include a first module that allows a user to provide credit card information, and another module that allows the user to initiate a purchase transaction using the credit card information provided via the credit card module. The purchase module may, for example, be configured to make a network call to a billing gateway to execute the purchase. When a purchase is attempted, the purchase module may receive an error message which relates to information provided via the credit card module (e.g., that the card number provided via the first module is invalid) which the purchase module is not capable of handling. In this respect, in some embodiments, a module may be equipped with a capability of querying a collection of error codes to determine whether that module is capable of handling a particular error message. If a module receives an error message which it is not capable of handling, that module may pass the error message to client-side platform 214, which may then determine (e.g., by polling other modules) which module can handle the error message.

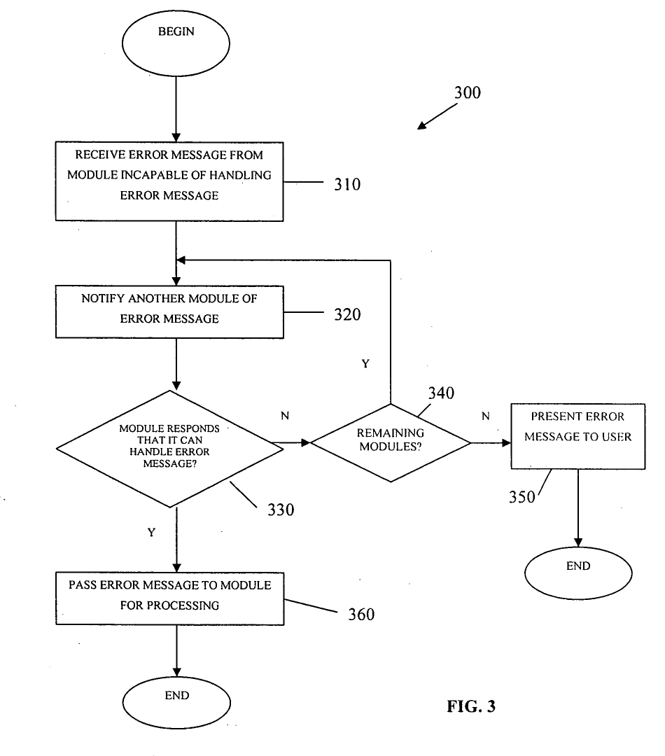

Using the example given above, if the purchase module receives the error message from the billing gateway, it may determine that it is not capable of handling the error message. For example, the purchase module may determine that the message includes an error code which it does not recognize. The purchase module may be configured to, upon making this determination, pass the error message to client-side platform 214, which may then perform exemplary process 300, shown in FIG. 3.

In performing exemplary process 300, client-side platform 214 polls the remaining modules to determine whether any of them can handle the error message, and if it determines that any module can, it passes the error message to that module for processing. At the start of process 300, client-side platform 214 receives an error message from a module which is incapable of handling the error message. As described above, this may be, for example, because the message includes an error code which the module does not recognize.

In act 320, client-side platform 214 sends a notification to another module included in the signup facility. The module to which the notification is sent may be determined in any suitable way (e.g., randomly), as the invention is not limited to any particular implementation. In some embodiments, the notification includes an indication of the error code, so that the module may execute a query to determine whether it can handle the error message.

In act 330, client-side platform 214 determines whether a response has been received from the module that it can handle the error message. If not, the process proceeds to act 340, wherein client-side platform 214 determines whether there are other modules in the signup facility which have not yet received a notification of the error message. If so, the process returns to act 320. If not, an error message is presented to the user, and process 300 completes.

If it is determined in act 330 that the module is capable of handling the error message, then the process proceeds to act 360, wherein client-side platform 214 passes the error message to the module for processing. Using the example given above, if the credit card module responds to client-side platform 214 that it can handle the error message, then client-side platform 214 need not poll other modules. Process 300 then completes.

The processing technique described above with reference to FIG. 3 is merely one example of a technique which can allow client-side platform 214 to provide error handling capabilities. Numerous other implementations are possible. For example, client-side platform 214 need not poll modules, as there may be other ways to determine which module may handle a particular error message. For example, client-side platform may maintain information indicating which module(s) may handle particular error messages. The invention is not limited to being implemented in any particular manner.

Client-side platform 214 may also enable one or more of module(s) 216 to share information, such that the modules present information and respond to user input in consistent fashion. For example, client-side platform 214 may employ session data 218 in executing module(s) 216, which may store information shared among one or more of module(s) 216. By allowing modules to share information, modules may be decoupled in the sense that no module need be concerned about or aware of the actions performed by other modules, but user actions taken with respect to one module which impact another module may be managed appropriately.

In some embodiments, session data 218 comprises a data structure storing name/value pairs. One or more of module(s) 216 may “subscribe” to values stored within session data 218, such that if a value to which a module subscribes changes (e.g., as a result of a user action with respect to another module), that module may be notified by client-side platform 214 so that appropriate processing may occur. Of course, session data 218 need not be implemented as a series of name/value pairs, as any of numerous other implementation techniques are possible.

Again employing as an illustrative example the signup facility described with reference to FIGS. 1A-1C, session data 218 may ensure that the domain name and account specified via modules 110 and 120, respectively, are consistent. In this example, assume that when the user specifies a domain name via module 110, session data 218 stores the domain name as a value, and that module 120 subscribes to that value. In some embodiments, if a user specifies a domain name via module 110 and an account via module 120, then returns to module 110 and changes the domain name, client-side platform 214 informs module 120 that the domain name has been changed so that it may perform appropriate processing, such as by attempting to validate (e.g., via a network call) that the account name corresponding to the new domain name is available. If not, module 120 may, for example, register an error with client-side platform 214, which may cause client-side platform 214 to give module 120 the focus (e.g., move it to an expanded state) and present an error message to the user.

In some embodiments, session data 218 may also serve as a cache for storing certain data temporarily, so that the data is not permanently stored prematurely. For example, certain data may be stored by a module with instructions for client-side platform 214 to provide it back to the module once the user has completed the signup process. As an example, module 110 may store the domain name provided by the user in session data 218, with instructions for client-side platform 214 to provide the domain name back to module 110 when the user completes the signup process. This feature may be useful, for example, if a module collects information that need not be stored permanently (e.g., so as to not unnecessarily occupy permanent storage resources) unless the signup process is completed. For example, module 110 may not communicate the domain name to server 240 immediately after receiving it from the user. Instead, module 110 may first attempt to verify that the domain name is available for registration, and not attempt to store it on server 240 until after the user completes the signup process.

In some embodiments, client-side platform 214 provides the capability of reporting on the performance of particular modules. For example, client-side platform 214 may track whenever a user exits a signup facility after causing the module to assume an expanded state.

By way of background, conventional multiple-page signup facilities are capable of tracking a user's exit from the signup facility only at the page level. Generally, this is performed via communication with an external reporting facility. For example, a server responding to a page request issued by a client may return a page which includes an image tag pointing to the reporting facility and identifying the signup page the user has requested, as well as other parameters. When the browser then loads the page, when it requests the image referenced by the image tag from the reporting facility, it passes the page identifier and parameters, informing the reporting facility of the page the user has requested. The reporting facility thus knows the last page requested by the user, and if the user does not request the last page in the signup process, the page from which the user exited the signup process.

As described above, signup facilities implemented in accordance with some embodiments of the invention may employ client-side components (e.g., module(s) 216) which communicate asynchronously with server 240, so that only a single page is required to present a signup facility. In order to track a user's progress through modules included on the page, client side platform 214 communicates with the reporting facility directly when the user navigates to a particular module. For example, each module may include an image tag pointing to the reporting facility, such that when the module is “opened” (e.g., caused by user input to assume an expanded state), client-side platform passes an identifier for the module to the reporting facility. In a similar fashion to that which is described above, the reporting facility knows the last module opened by the user, and if the user does not complete the signup process, the module from which the user exited the signup process. In this manner, embodiments of the invention may track and report on whether particular modules are more likely to cause a user to fail to complete the signup process.

### IV. Server-Side Processing

In some embodiments, server-side platform component 242 employs session data 250 to coordinate the execution of module(s) 216 and/or client-side platform 214 on client 210. For example, in some embodiments session data 250 is used to ensure that web services are not abused by malicious users. In this respect, web services which support components that communicate asynchronously must typically be made publicly accessible, such that any user may access them. To prevent abuse of these web services, in some embodiments, session data 250 is employed to identify malicious users. Session data 250 may be used to identify users which employ a web service without proceeding through the order of modules which is defined on a signup facility. In addition, once users are identified that employ a web service without proceeding through the defined order of modules, session data 250 may be employed in any suitable way.

Using the example once again of the signup facility depicted by FIGS. 1A-1C, if module 110 (FIG. 1A) makes a call to a web service to check if the domain name specified by a user is available for registration, in some embodiments, session data 250 is updated to reflect that the domain name web service has been called. When the user then proceeds to module 120 and specifies an account name, such that module 120 makes a call to a web service to determine whether the account already exists, in some embodiments session data 250 is checked to determine whether the domain name web service has been called. As such, session data 250 (as implemented by server-side platform component 242) may prevent a user from calling a web service outside the order specified by a signup facility. Thus, if a malicious or unauthorized user simply called a web service to create an account without first calling the domain name service, the request may be denied.

In some embodiments, server-side platform component 242 is also configured to track and report on the performance of particular experiences in converting users to signed up customers. In this respect, as described above, server-side platform component 242 may cause multiple variations of a single page signup facility to be presented the user via browser 212. Each variation may include a different combination and/or number of modules, to create a particular user experience.

In some embodiments, server-side platform component 242 tracks whether certain experiences are more successful than others at converting users to signed-up customers. For example, in some embodiments, server-side platform component 242 tracks the experience shown to each user, and whether the user completed the signup process. This may be useful, for example, for identifying particularly successful experiences, which an administrator may decide thereafter to present to all users.

V. Module, Signup Facility and/or Experience Definition

As described above, a platform implemented in accordance with some embodiments of the invention may be flexible and extensible in that modules may be developed (e.g., by one or more parties) and included, removed from and modified within various signup facilities and/or experiences, without any changes to the platform itself. In one example, a module may be developed for inclusion within a particular signup facility, and multiple experiences may be defined as variations of that signup facility, some or all of which may include the module. In another example, different parties may each develop and contribute a different module which is included in a particular signup facility. In yet another example, a module (e.g., developed by a first party) which has not proved particularly effective in converting users to signed-up customers may be swapped out of a particular experience or signup facility and replaced by another module (e.g., developed by a second party). Numerous other uses and applications for the extensible, scalable platform provided by embodiments of the invention may be envisioned by those skilled in the art.

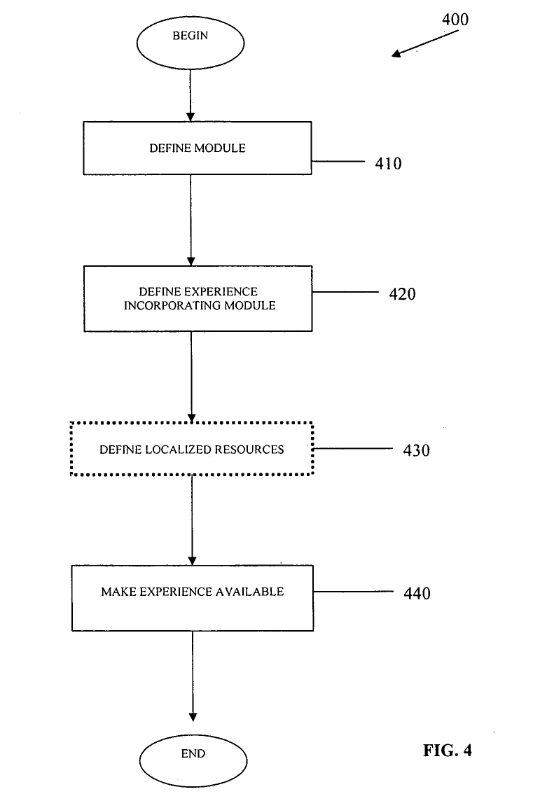

FIG. 4 depicts an exemplary process 400 which may be performed to define a particular module and include the module within a single-page sign up facility, and/or an experience defining a variation thereof, for presentation to the user. At the start of process 400, in act 410, a module is defined. This may be performed in any of numerous ways. In some embodiments, a module may be designed to collect a portion of the signup information to be collected from the user overall. For example, a module may be designed to collect a set of logically related items. Using the example described above with reference to FIGS. 1A-1C, a first module may collect information related to domain name registration, a second module may collect account information, a third module may collect user contact information, etc. Each module may present one or more input mechanisms each designed to collect a particular item of information.

In some embodiments, a module is implemented as a Javascript object, such that act 410 may involve developing code in Javascript using object-oriented programming techniques. In some embodiments, a Javascript object is designed to extend and inherit from a base class defining event handling functionality, such as that which is described above as being provided by client-side platform 214 (FIG. 2). However, the invention is not limited in this respect, as a module may include any suitable programmed instructions defining any suitable functionality. Numerous implementations are possible.

The process then proceeds to act 420, wherein an experience is defined which incorporates the module defined in act 410. This also may be performed in any of numerous ways. For example, a new experience may be created, or an existing experience may be modified, to include the module defined in act 410. In some embodiments, each experience is maintained by experience manager 244 (FIG. 2) as a record, object and/or other indication, which may include a reference to one or more modules to be presented to the user via the experience. For example, a record defining an experience may include a unique identifier for each module included in the experience. An identifier may be associated with the module defined in act 410, and may be employed by Javascript handler 246 to access the module (e.g., from a database). Of course, an experience need not be defined or implemented in this fashion, as numerous other implementations are possible.

The process may then proceed to act 430, wherein localized resources may be defined for the module. As indicated by the dotted line, act 430 is optional and may not be performed, as localized resources may not be required for some modules. As described above, localized resources may allow a module to be customized to suit a particular characteristic of a request issued by a client for a particular signup facility, such as the geographic location from which it originates. For example, localized resources may include information that allows input mechanisms to be labeled using a language and/or character set appropriate for the geographic location.

The process then proceeds to act 440, wherein the experience is made available. This also may be performed in any of numerous ways. For example, experience manager 244 (FIG. 2) may be configured to employ the experience defined in act 420 when server-side platform component 242 communicates with experience manager 244 in response to receiving a request for a signup facility from client 210. As described above, experience manager 244 may employ an algorithm that defines which experience is provided to server-side platform component 242 in response to a signup facility request. As a result, in some embodiments, the experience defined in act 420 may be made available by modifying this algorithm to account for the experience. Of course, numerous other techniques may be employed to make an experience available, as the invention is not limited to any particular implementation.

Upon the completion of act 440, process 400 completes. Thereafter, the module defined in act 410 may be presented to the user via a signup facility. Specifically, the module and localized resources defined in acts 410 and 430, respectively, may be identified to Javascript handler 246 and cascading resource manager 248. The experience may be identified to experience manager 244. At the completion of act 440, process 400 completes.

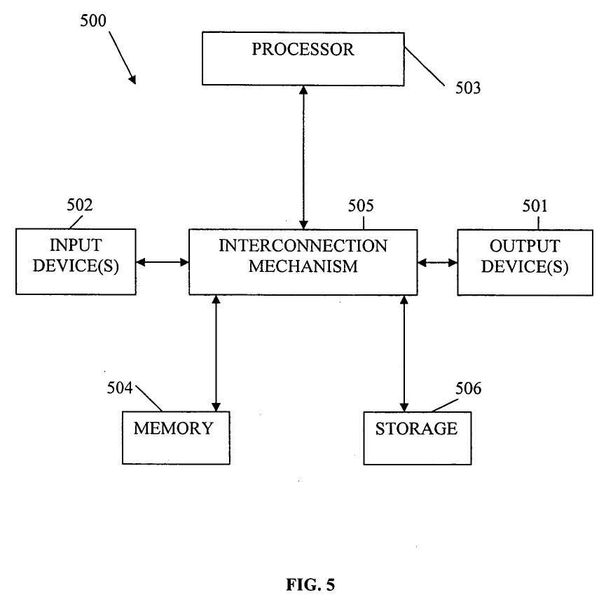

Various aspects of the systems and methods for practicing features of the invention may be implemented on one or more computer systems, such as the exemplary computer system 500 shown in FIG. 5. Computer system 500 includes input devices 502, output devices 501, processor 503, memory system 504 and storage 506, all of which are coupled, directly or indirectly, via interconnection mechanism 505, which may comprise one or more buses, switches, networks and/or any other suitable interconnection. The input devices 502 receive input from a user or machine (e.g., a human operator, or telephone receiver), and the output devices 501 display or transmit information to a user or machine (e.g., a liquid crystal display). The processor 503 typically executes a computer program called an operating system (e.g., a Microsoft Windows (R)-family operating system or other suitable operating system) which controls the execution of other computer programs, and provides scheduling, input/output and other device control, accounting, compilation, storage assignment, data management, memory management, communication and data flow control. Collectively, the processor and operating system define the computer platform for which application programs in other computer programming languages are written.

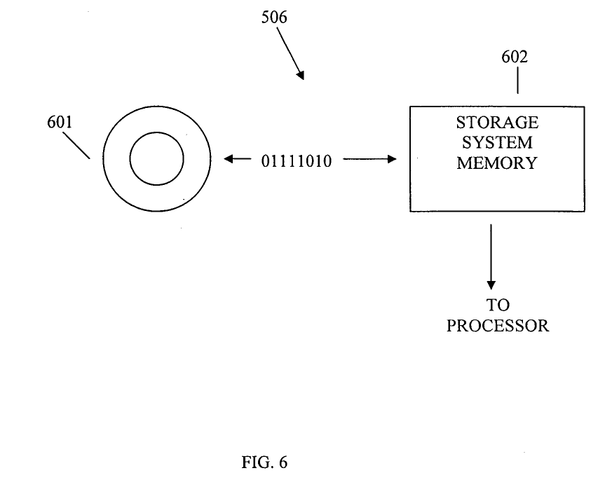

The processor 503 may also execute one or more computer programs to implement various functions. These computer programs may be written in any type of computer programming language, including a procedural programming language, object-oriented programming language, macro language, or combination thereof. These computer programs may be stored in storage system 506. Storage system 506 may hold information on a volatile or nonvolatile medium, and may be fixed or removable. Storage system 506 is shown in greater detail in FIG. 6.

Storage system 506 typically includes a computer-readable and writeable nonvolatile recording medium 601, on which signals are stored that define a computer program or information to be used by the program. The medium may, for example, be a disk or flash memory. Typically, in operation, the processor 503 causes data to be read from the nonvolatile recording medium 601 into a volatile memory 602 (e.g., a random access memory, or RAM) that allows for faster access to the information by the processor 503 than does the medium 601. This memory 602 may be located in storage system 506, as shown in FIG. 5, or in memory system 604, as shown in FIG. 6. The processor 503 generally manipulates the data within the integrated circuit memory 504, 602 and then copies the data to the medium 601 after processing is completed. A variety of mechanisms are known for managing data movement between the medium 601 and the integrated circuit memory element 504, 602, and the invention is not limited thereto. The invention is also not limited to a particular memory system 604 or storage system 506.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. In a system comprising a client computer, a server computer and at least one communication medium coupling the client computer to the server computer, the client computer executing a browser program operable to display to a user at least one web page provided by the server computer to the client computer, a method of providing a platform for presenting a signup facility operable to receive signup information from the user via a signup process, the method comprising acts of:
(A) providing a server-side platform component operable to respond to a request issued by the browser program for the signup facility;
(B) providing a plurality of modules for inclusion in the signup facility, each module being configured to receive a portion of the signup information from the user, each portion comprising a set of logically related items; and
(C) providing a client-side platform component which, when executed on the client, manages the execution of the plurality of modules to present the signup facility.

2. The method of claim 1, wherein at least one of the plurality of modules is capable of assuming a plurality of states on the signup facility, the plurality of states comprising a first state in which one or more input mechanisms are presented to the user for providing signup information and a second state wherein the module occupies less viewable area than in the first state.

3. The method of claim 1, further comprising an act of:
(D) providing an experience manager component which communicates with the server-side platform component and which is operable to, in response to the server-side platform component receiving a request from the browser program for the signup facility, define a plurality of variations of the signup facility, each of the plurality of variations defining an experience.

4. The method of claim 3, wherein the act (A) further comprises providing a server-side platform component operable to track a frequency at which each experience results in a completion of the signup process.

5. The method of claim 1, wherein the act (B) further comprises transmitting the plurality of modules to the client computer.

6. The method of claim 1, wherein the act (C) further comprises providing a client-side platform component operable to, in response to the user initiating an action via one of the plurality of modules in the signup facility, poll at least one other of the plurality of modules to determine whether initiating the action is desirable.

7. The method of claim 1, wherein the act (C) further comprises providing a client-side platform component operable to, in response to one of the plurality of modules receiving an error message which the module is incapable of handling, determine whether another of the plurality of modules is capable of handling the error message.

8. The method of claim 1, wherein the act (C) further comprises providing a client-side platform component operable to track of a frequency at which a user's interaction with each of the plurality of modules results in the user exiting the signup process.

9. The method of claim 1, wherein the act (B) further comprises providing a plurality of modules operable to communicate asynchronously with the server-side platform component.

10. At least one computer-readable medium having instructions encoded thereon which, when executed in a system comprising a client computer, a server computer and at least one communication medium coupling the client computer to the server computer, the client computer executing a browser program operable to display to a user at least one web page provided by the server computer to the client computer, perform a method of defining a signup facility for receiving signup information from the user via a signup process, the method comprising acts of:
(A) accepting a module for inclusion in the signup facility, the module being configured to receive a portion of the signup information from the user, the portion comprising a set of logically related items;
(B) incorporating the module into the signup facility; and
(C) making the signup facility available for download by the client.

11. The at least one computer-readable medium of claim 10, wherein the act (A) further comprises accepting a module capable of assuming a plurality of states on the signup facility, the plurality of states comprising a first state in which one or more input mechanisms are presented to the user for providing signup information and a second state wherein the module occupies less viewable area than in the first state.

12. The at least one computer-readable medium of claim 10, wherein the act (B) further comprises incorporating the module into a plurality of variations of the signup facility, each variation defining an experience, and wherein the act (C) further comprises making the plurality of experiences available for download by the client.

13. The at least one computer-readable medium of claim 10, wherein the act (B) further comprises incorporating the module into a portion of a plurality of variations of the signup facility, each variation defining an experience, and wherein the act (C) further comprises making the plurality of experiences available for download by the client.

14. The at least one computer-readable medium of claim 10, wherein the act (A) further comprises accepting a plurality of modules for inclusion in the signup facility, each module being accepted from a different party.

15. A server computer for use in a system comprising the server computer, a client computer, and at least one communication medium coupling the client computer to the server computer, the client computer executing a browser program operable to display to a user at least one web page provided by the server computer to the client computer, the server computer comprising a server-side platform component operable to:
respond to a request issued by the browser program for a signup facility for receiving signup information from the user via a signup process; and
provide to the client, in response to the request:
a plurality of modules for inclusion in the signup facility, each module being configured to receive a portion of the signup information from the user, each portion comprising a set of logically related items; and
a client-side platform component which, when executed on the client, manages the execution of the plurality of modules to present the signup facility.

16. The server computer of claim 15, wherein the server-side platform component is further operable to accept each of the plurality of modules from different parties.

17. The server component of claim 15, further comprising:
an experience manager component in communication with the server-side platform component which is operable to, in response to the server-side platform component receiving a request from the browser program for the signup facility, define a plurality of variations of the signup facility, each of the plurality of variations defining an experience, each experience including a different combination of modules; and
wherein the server-side platform component is further operable to, in response to the request, provide a plurality of modules defining an experience to the client.

18. The server computer of claim 17, wherein the server-side platform component is further operable to track a frequency at which each of the plurality of experiences results in a completion of the signup process.

19. The server computer of claim 15, wherein the at least one of the plurality of modules is capable of assuming a plurality of states on the signup facility, the plurality of states comprising a first state in which one or more input mechanisms are presented to the user for providing signup information and a second state wherein the module occupies less viewable area than in the first state.

20. The server computer of claim 15, wherein the server-side platform component is further operable to provide the plurality of modules to be presented in the signup facility in a predefined sequence, and to store information indicating whether the user interacted with the plurality of modules in the predefined sequence.
